(19) United States
(12) Patent Application Publication
(10) Pub. No.: US 2026/0202228 A1
(43) Pub. Date: Jul. 16, 2026

(54) ULTRASONIC FLOWMETER AND METHOD FOR OPERATING AN ULTRASONIC FLOWMETER

(71) Applicant: KROHNE AG, Basel (CH)

(72) Inventors: Jack MASSAAD, Dordrecht (NL); Johannes Cornelis HOGENDOORN, Spijk (NL); Michael VOGT, Bochum (DE)

(73) Assignee: KROHNE AG, Basel (CH)

(21) Appl. No.: 19/450,308

(22) Filed: Jan. 15, 2026

(30) Foreign Application Priority Data
Jan. 16, 2025 (DE) 10 2025 101 416.7

(51) Int. Cl. G01F 1/66; G01F 1/667; G01N 9/24

(52) U.S. Cl. CPC G01F 1/662; G01F 1/667; G01N 9/24

(57) ABSTRACT

An Ultrasonic flowmeter having a measuring tube, a first ultrasonic transducer array, a second ultrasonic transducer array and a control and evaluation unit. A medium flows through the measuring tube during operation. The first array and the second array are arranged on the measuring tube at a distance from one another as viewed in the direction of flow. The control and evaluation unit is connected to the first ultrasonic transducer array and to the second ultrasonic transducer array. In a first operating state, the first ultrasonic transducer array is designed at least as an ultrasonic stimulator for the excitation of a guided ultrasonic wave which is propagated through the medium during operation, and wherein the second ultrasonic transducer array is designed at least as an ultrasonic receiver for receiving this ultrasonic wave. The first ultrasonic transducer array has a plurality of transducer elements arranged on a first measuring tube circumference.

This nonprovisional application claims priority under 35 U.S.C. § 119(a) to German Patent Application No. 10 2025 101 416.7, which was filed in Germany on Jan. 16, 2025, and which is herein incorporated by reference.

### BACKGROUND OF THE INVENTION

### Field of the Invention

The invention is based on an ultrasonic flowmeter comprising a measuring tube, a first ultrasonic transducer array, a second ultrasonic transducer array and a control and evaluation unit, wherein a medium flows through the measuring tube during operation, wherein the first ultrasonic transducer array and the second ultrasonic transducer array are arranged on the measuring tube at a distance from one another as seen in the direction of flow of the flowing medium, wherein the control and evaluation unit is connected to the first ultrasonic transducer array and to the second ultrasonic transducer array, wherein, in a first operating state, the first ultrasonic transducer array is designed at least as an ultrasonic stimulator for the excitation of a guided ultrasonic wave, which is propagated through the medium during operation, and wherein the second ultrasonic transducer array is designed at least as an ultrasonic receiver for receiving this ultrasonic wave.

Furthermore, the invention relates to a method for operating an ultrasonic flowmeter according to the invention, wherein a medium flows through the measuring tube, and wherein, in a first operating state, the first ultrasonic transducer array functions as an ultrasonic stimulator and the second ultrasonic transducer array functions as an ultrasonic receiver and wherein, in a second operating state, the first ultrasonic transducer array functions as an ultrasonic receiver and the second ultrasonic transducer array functions as an ultrasonic stimulator.

### Description of the Background Art

Ultrasonic flowmeters comprising ultrasonic transducer arrays for emitting and receiving an ultrasonic signal are known from the prior art.

It is also known to excite a guided ultrasonic wave in the measuring tube, which propagates along the measuring tube axis. For example, it is known to excite such an ultrasonic wave with a piezoelectric ring that surrounds the measuring tube and to receive it with a second piezoelectric ring that also surrounds the measuring tube. The publication U.S. Pat. No. 10,365,137 B2 discloses an ultrasonic flowmeter wherein a first ultrasonic transducer in the form of a first piezoelectric ring divided into at least two parts and a second ultrasonic transducer in the form of a second piezoelectric ring divided into at least two parts are arranged on a measuring tube. During operation, the at least two parts of the first piezo ring can be controlled together in order to excite an ultrasonic wave in the measuring tube. The subdivision into two or three separate parts can compensate for fluctuations in the dimensions of the measuring tube.

### SUMMARY OF THE INVENTION

Based on the prior art described above, the object of the present invention is to provide an ultrasonic flowmeter that ensures particularly good measurement of the medium. In addition, the object of the invention is to provide a method for operating an ultrasonic flowmeter with which the flowing medium can be measured particularly well.

According to a first teaching of the present invention, the aforementioned object is achieved in that the first ultrasonic transducer array has a plurality of transducer elements, wherein the plurality of transducer elements is arranged on a first measuring tube circumference, that the second ultrasonic transducer array has a plurality of transducer elements, wherein the plurality of transducer elements is arranged on a second measuring tube circumference and that the transducer elements are small compared to the circumference of the measuring tube.

The transducer elements of the first ultrasonic transducer array are arranged on or along a circumference of the measuring tube in such a way that, during operation, they stimulate a pressure distribution in the measuring tube, which continues as a guided ultrasonic wave inside the measuring tube in the direction of the second ultrasonic transducer array. The ultrasonic wavefield excited by the first ultrasonic transducer array propagates in the measuring tube as a guided wave.

According to an example, the transducer elements of an ultrasonic transducer array can be controlled together in parallel. According to an alternative design, the transducer elements are contacted in such a way that at least two transducer elements, preferably all transducer elements, can be controlled separately.

The possibility of controlling the individual transducer elements separately means that, in principle, different pressure distributions can be introduced into the medium and different ultrasonic waves or different wave modes can therefore be excited. In addition, as will be explained in detail below, separate control can be used to compensate for fluctuations, for example in the measuring tube dimensions.

Preferably, the transducer elements of the ultrasonic stimulator array excite a flat ultrasonic wavefield whose wavefront essentially fills the inner diameter of the measuring tube and thus takes the entire flow profile into account. The advantage of this design is that all velocity components of the flow profile can be taken into account with a continuous time measurement when determining the transit time of this wave and when subsequently determining the velocity of the flowing medium.

According to the invention, it has been recognized that the excitation and also the reception of such a plane wavefield can be implemented particularly well with the aid of two ultrasonic transducer arrays arranged on the measuring tube.

The measuring tube according to the invention has an outer measuring tube circumference, which is defined by the outer measuring tube wall when looking at the measuring tube cross-section. Furthermore, the measuring tube has an inner measuring tube circumference, which is defined by the inner measuring tube wall when the measuring tube cross-section is viewed.

When it is stated that the transducer elements are arranged on a measuring tube circumference, this means that the transducer elements can be arranged on the outer measuring tube circumference or on the inner measuring tube circumference, and thus can be arranged inside the measuring tube. In addition, this wording also includes designs according to which, for example, a coupling layer or another layer which is used to arrange the transducer elements on the measuring tube can be present between the inner or outer measuring tube wall and the transducer elements.

The measuring tube can be part of an existing pipe system or a measuring tube that can be connected to the pipes of a pipe system, for example via a flange connection, or the measuring tube can be a measuring tube insert that can be inserted into a pipe of an existing system.

To implement a flat wavefront, the transducer elements are preferably controlled during operation in such a way that the wavelength of the ultrasonic wave essentially corresponds to the inner diameter of the measuring tube.

Depending on different parameters, such as medium parameters, the frequency of the excited ultrasonic wave and boundary conditions of the measuring tube, such as the measuring tube diameter, different wave modes can propagate in the measuring tube. In addition, different wave modes can be excited in the medium by controlling the transducer elements.

When it is said that the individual transducer elements are designed to be small compared to the circumference of the measuring tube, this means, according to one design, that the expansion of a transducer element in the direction of the measuring tube circumference is smaller than a quarter of the circumference of the measuring tube. Preferably, the dimension in the direction of the measuring tube circumference of a transducer element is smaller than one eighth of the circumference of the measuring tube, particularly preferably the dimension in the direction of the measuring tube circumference is smaller than one sixteenth of the circumference of the measuring tube. According to one design, the size of the transducer elements is in the μm range or in the mm range or in the cm range.

For example, the diameter of a transducer element that is essentially designed in the shape of a disk and has a circular base is between 50 μm and 350 μm and the thickness of such a transducer element is between 0.5 μm and 3 μm.

According to an example, the diameter of the measuring tube is between 1 and 10 mm. The size of the transducer elements, for example the diameter of an essentially circular base surface, is particularly preferably between 0.5 and 5 mm. If the diameter of the measuring tube is between 1 and 10 cm, the size of the transducer elements, for example the diameter of an essentially circular base surface, is between 1 and 5 cm.

According to a further design, the wall thickness of the measuring tube is between 1 mm and 10 mm.

According to a next preferred design, the transducer elements are designed and arranged along the circumference of the measuring tube in such a way that the total area of the transducer elements covers at least 50% of the circumference of the measuring tube. The total area of the transducer elements corresponds to the sum of the individual areas of the transducer elements in cross-section in the area of the first measuring tube circumference.

Particularly preferably, the transducer elements cover more than 50%, for example more than 60% or more than 70% of the circumference of the measuring tube. Particularly preferably, the transducer elements are arranged axially symmetrically in relation to the longitudinal axis of the measuring tube.

In particular, the transducer elements can be dimensioned in dependence on the circumference of the measuring tube in such a way that the transducer elements have full-surface contact with the inner or outer measuring tube wall or, if present, the intermediate layer between the transducer elements and the inner or outer measuring tube wall in the assembled state.

According to an example, the device according to the invention is therefore used with small measuring tube dimensions. However, the invention is by no means limited to this. It is also conceivable and advantageous to use this arrangement with larger measuring tube diameters, in particular with larger transducer elements.

For example, the transducer elements can be designed in the shape of a disk, wherein the diameter of the circular base of a transducer element is between 1 and 10 mm or between 1 and 10 cm, for example. It is also conceivable that the transducer elements are designed to be even larger, particularly in the case of large diameters of the measuring tubes.

In addition, the transducer elements can also be designed in a cuboid shape with a rectangular base. Preferably, the rectangular transducer elements are arranged on a measuring tube circumference in such a way that the longer side of the rectangle extends in or against the direction of flow of the medium.

According to the invention, in contrast to the prior art, an ultrasonic transducer array with, preferably separately controllable, transducer elements is arranged on the circumference of the measuring tube rather than an interrupted piezoelectric ring. The ultrasonic transducer array can be designed to be one-dimensional or two-dimensional. More detailed designs are described below.

The arrangement of a plurality of separately controllable transducer elements along the circumference of the measuring tube has the advantage that all transducer elements or only some transducer elements, in particular groups of transducer elements, can be controlled. Such flexible control allows different pressure distributions and thus different wave modes to be excited in the measuring tube. In addition, the design of the ultrasonic receiver as an array of transducer elements arranged along the second measuring tube circumference has the advantage that the ultrasonic wavefield propagating in the measuring tube can be captured with all transducer elements or with only certain transducer elements, so that the desired wave mode can be filtered out by selectively capturing the ultrasonic wavefield with determined transducer elements.

Furthermore, the selective capture of the ultrasonic wavefield with only determined transducer elements can suppress interference components, which are due, for example, to unwanted reflections of the ultrasonic wave on the measuring tube wall or to signal components propagating in the measuring tube wall, in that the transducer elements on which these interference components impinge do not transmit a signal to the control and evaluation unit.

The first ultrasonic transducer array and/or the second ultrasonic transducer array is/are preferably designed as an array of PMUT (piezoelectric micromachined ultrasonic transducer) transducer elements or as an array of CMUT (capacitive micromachined ultrasonic transducer) transducer elements or as an array of PVdF (polyvinylidene fluoride) transducer elements.

It is particularly preferred that the first ultrasonic transducer array and the second ultrasonic transducer array are identical in terms of the number of transducer elements and/or the arrangement of the transducer elements on the respective measuring tube circumference and/or in terms of the size of the transducer elements.

Furthermore, it is preferred if a defined number of transducer elements of the first ultrasonic transducer array are controlled in such a way that a plane wavefront is excited in the medium, and if the transducer elements of the second ultrasonic transducer array capturing the wavefront correspond to the transducer elements of the first ultrasonic transducer array in terms of number and arrangement on the circumference of the measuring tube.

According to a preferred design, the individual transducer elements are designed as piezo elements.

The individual transducer elements can be designed and contacted in such a way that they oscillate in thickness mode during operation in order to excite or capture an ultrasonic wave in the measuring tube. In other words, the individual transducer elements oscillate in the direction of the electric field that is applied to the transducer elements for actuation, if the individual transducer elements are designed to be essentially cylindrical or cuboid and the transducer elements are contacted at the base surfaces. In particular, the transducer elements are arranged on the circumference of the measuring tube, for example on the outer measuring tube wall or on the inner measuring tube wall, in such a way that the individual transducer elements oscillate perpendicular to the outer measuring tube wall or to the inner measuring tube wall.

According to a preferred design, the transducer elements of the first ultrasonic transducer array can be arranged on a flexible band that is placed around the measuring tube. It is particularly preferred if the transducer elements are arranged essentially equidistant from one another on the band. An equidistant arrangement of the transducer elements on the band also ensures a uniform arrangement of the transducer elements along the circumference of the measuring tube, so that the ultrasonic signal in the measuring tube can also be excited particularly uniformly as a result.

For example, a flexible band is an elastically or plastically deformable band that can be placed around the measuring tube. In particular, the flexible band is not rigid but pliable.

In addition, the transducer elements of the second ultrasonic transducer array can be arranged on a flexible band that is placed around the measuring tube. In a particularly advantageous manner, these transducers are also arranged essentially equidistant from one another on the flexible band.

In the mounted state, according to one design, the flexible band is arranged between the transducer elements and the measuring tube. According to an example, the flexible band is arranged on the side of the transducer elements facing away from the measuring tube in the mounted state. According to this design, the transducer elements are in direct contact with the outer or inner measuring tube wall. According to a further design, an acoustic coupling layer is arranged between the transducer elements and the outer or inner measuring tube wall.

If the flexible band is arranged between the transducer elements and the measuring tube when mounted, the flexible band can be designed as an acoustic coupling layer.

Particularly preferably, the transducer elements are arranged primarily, i.e. before mounting on the measuring tube, preferably in a row, on the flexible band. According to another design, the transducer elements are arranged as a two-dimensional array on the flexible band. For example, the transducer elements can be arranged in two or more rows on the band before the band is placed around the measuring tube. For example, the transducer elements are glued or soldered to the band.

The band is then placed around the measuring tube or inserted inside the measuring tube and fixed to the measuring tube. The band is placed around the measuring tube in such a way that the transducer elements are arranged along the circumference of the measuring tube. Preferably, the transducer elements are designed and arranged in such a way that they cover at least 50% of the circumference of the measuring tube. The arrangement on such a flexible band has the advantage that such a band can be arranged on different measuring tubes that differ in diameter. In this respect, such a band with transducer elements can be used particularly flexibly.

Alternatively, such a band can also be attached to the inside of the measuring tube. According to one design, such a band can be glued to the inner measuring tube wall. The cables for contacting the transducer elements can be routed through the inside of the measuring tube to a flange connection. The measuring tube can be integrated into an existing pipe system via this flange connection. For this purpose, measuring tube flanges are provided at the ends of the measuring tube, which can be connected to the tube flanges arranged on the pipes to be connected. In addition, the ultrasonic flowmeter can have at least one connecting element that is clamped between a measuring tube flange and a pipe flange when installed. The cable connection of the transducer elements can be routed through this connecting element into the exterior space of the measuring tube so that the transducer elements in the exterior space can be contacted by the control and evaluation unit. For example, the at least one connecting element is designed as a connecting circuit board, preferably wherein the connecting circuit board has internal conductor tracks at least in some areas. Alternatively, the connecting element can have at least one channel for guiding the cable or cables for contacting the transducer elements. In the assembled state, the at least one cable can be routed through the at least one channel into the exterior space of the measuring tube. Such a channel is sealed towards the exterior space, for example using epoxy resin or a liquid-tight or gas-tight nut with a feed-through.

In addition, the measuring tube on which the transducer elements of the ultrasonic transducer arrays are arranged can be designed as an insert, wherein the insert is inserted into a tube of an existing pipe system for operation. The transducer elements can be contacted as described above, for example via a connecting element. Alternatively, the contact can be implemented via at least one hole in the pipe wall of the existing pipe system.

If the flexible band is arranged on the outer circumference of the measuring tube, the flexible band can be arranged in at least two windings according to one design. According to this design, the transducer elements are then arranged in a two-dimensional array on the measuring tube, wherein the transducer elements of two windings can be offset with respect to each other in relation to the position on the measuring tube circumference or arranged directly next to each other. During operation, the medium can be excited in a spiral depending on the arrangement of the transducer elements of a second winding in relation to the transducer elements of a first winding. Such spiral excitation can be compensated for or at least reduced by a time-delayed control of the transducer elements of the second winding compared to the control of the transducer elements of the first winding. Preferably, the time offset is dimensioned in such a way that the desired pressure distribution of the ultrasonic wave introduced by the transducer elements of the first winding is amplified by the transducer elements of the second winding. Furthermore, applying a time offset has the advantage that it can be ensured that the effective cross-section plane of the pipe being excited is essentially perpendicular to the pipe axis.

According to an example, such an arrangement is also conceivable in the event that the flexible band is arranged on the inner measuring tube wall.

According to an example, the flexible band can be designed as a flexible printed circuit board.

Particularly preferably, the transducer elements of the first ultrasonic transducer array can be arranged on a flexible printed circuit board, which is arranged on the outer measuring tube wall and/or the transducer elements of the second ultrasonic transducer array are arranged on a flexible printed circuit board, which is arranged on the outer measuring tube wall.

The arrangement of the transducer elements on a flexible printed circuit board has the advantage that the transducer elements can be contacted particularly easily. According to this design, the control and evaluation unit is also connected to the flexible printed circuit board or flexible printed circuit boards.

As already explained, the circuit board or circuit boards can also be arranged inside the measuring tube on the inner measuring tube wall.

A next design of the ultrasonic flowmeter is characterized in that the transducer elements of the first ultrasonic transducer array are arranged substantially equidistantly along the complete first measuring tube circumference and/or that the transducer elements of the second ultrasonic transducer array are arranged substantially equidistantly along the complete second measuring tube circumference.

With an essentially equidistant arrangement of the transducer elements along the complete first or second measuring tube circumference, so that the transducer elements cover an angle of 360° taking into account the distances from each other, a particularly uniform excitation of a flat ultrasonic wave in the medium is possible. When it is said that the transducer elements cover an angle of 360°, taking into account the distances between them, this means that the total area of the transducer elements can also cover less than 360° of the measuring tube circumference, but that the transducer elements are then arranged at a distance from each other along the complete measuring tube circumference.

For example, the total area of the transducer elements can cover between 50% and 80% of the circumference of the measuring tube. The transducer elements of the ultrasonic stimulator are particularly preferably arranged in such a way that they can excite the medium axially symmetrically in relation to the measuring tube axis. For example, two, four, six or eight transducer elements are arranged along the circumference of the first measuring tube, wherein two transducer elements are preferably diametrically opposite each other. According to another design, a number between 2 and 32 transducer elements or between 2 and 16 transducer elements or between 2 and 8 transducer elements are arranged along the circumference of the first measuring tube. If the number of transducer elements is even, two transducer elements are preferably situated diametrically opposite each other.

It is particularly advantageous if the number and size of the transducer elements is matched to the circumference of the measuring tube in such a way that an ultrasonic transducer array has as many transducer elements as possible which, in the assembled state, have surface contact with the inner or outer measuring tube wall or with the intermediate layer, and that the number of transducer elements is limited upwards by the complexity of the control of the transducer elements.

Particularly preferably, the number and arrangement of the transducer elements of the second ultrasonic transducer array corresponds to the number and arrangement of the transducer elements of the first ultrasonic array.

According to an advantageous design of the ultrasonic flowmeter, the transducer elements of an ultrasonic transducer array can be controlled separately. According to a preferred design, during operation at least two transducer elements are controlled simultaneously, i.e. at the same time and with the same amplitude. According to another design, diametrically opposite transducer elements are controlled in the same way during operation. This type of control can stimulate an axially symmetrical pressure distribution in the medium in relation to the measuring tube axis.

At least two transducer elements arranged along the circumference are driven with a phase time shift and/or with a different amplitude. According to this design, irregularities, such as irregularities in the measuring tube wall, for example fluctuations in the thickness of the measuring tube and/or fluctuations in the roundness of the measuring tube or irregular distances between the transducer elements can be compensated for.

If, for example, a transducer element is arranged at a point on the measuring tube where the measuring tube has a smaller wall thickness than in the rest of the measuring tube, this transducer element can be emitted with a slight time delay so that the signal emitted by this transducer element reaches the medium at the same time as the signal emitted by the diametrically opposite transducer element, for example.

As a result, the transducer elements of the ultrasonic transducer array serving as an ultrasonic stimulator are controlled in such a way that a signal of uniform amplitude is excited by the transducer elements in the medium at the same time.

The transducer elements of the ultrasonic receiver are preferably arranged in such a way that they can capture the pressure distribution in the medium over the full circumference of the measuring tube. This means that the total area of the transducer elements can cover 360° or even less than 360° and that the transducer elements are arranged at a distance from each other along the complete circumference of the measuring tube. For example, the total area of the transducer elements can cover between 50% and 80%. As the transducer elements of the receiver array can also be evaluated separately, it is possible to capture specific wave modes or filter out interfering signals by evaluating only certain transducer elements. If the ultrasonic wavefield excited in the medium is only captured by some transducer elements of the receiving transducer array, a determined pressure distribution, in particular a desired wave mode, can be selectively picked out from the ultrasonic wavefield propagating in the medium.

The first ultrasonic transducer array in a second operating state can also be designed as an ultrasonic receiver for receiving an ultrasonic wave and the second ultrasonic transducer array in a second operating state is also designed as an ultrasonic stimulator for exciting an ultrasonic wave that propagates through the medium during operation. With this design, the transit time of an ultrasonic signal that propagates in a first operating state, for example in the direction of flow, and the transit time of an ultrasonic signal that propagates against the direction of flow in a second operating state can be determined. The flow velocity of the flowing medium can be determined from the difference in transit time.

The ultrasonic flowmeter can also determine further parameters of the medium and/or the measuring arrangement during operation. For this purpose, the first ultrasonic transducer array is designed such that, in a third operating state, at least one transducer element is at least temporarily designed as an ultrasonic stimulator and at least one transducer element is at least temporarily designed as an ultrasonic receiver and/or the second ultrasonic transducer array is designed such that, in a third operating state, at least one transducer element is at least temporarily designed as an ultrasonic stimulator and at least one transducer element is at least temporarily designed as an ultrasonic receiver.

For example, in the third operating state, a transducer element of the first ultrasonic transducer array can function first as an ultrasonic stimulator and then as an ultrasonic receiver. Alternatively, one transducer element can function as an ultrasonic stimulator and another transducer element, in particular the transducer element diametrically opposite the first transducer element, can function as an ultrasonic receiver. The same applies to the design of the transducer elements of the second ultrasonic transducer array.

The first ultrasonic transducer array and/or the second ultrasonic transducer array can therefore also be operated autonomously.

This design has the advantage that not only the flow rate of the flowing medium can be determined, but also other parameters of the medium or the measuring arrangement. Other parameters include, for example, the thickness of the measuring tube wall, the roundness of the measuring tube, or the density of the medium.

As a result, a flowmeter in various designs is described which, due to the arrangement and design of the ultrasonic transducer arrays, ensures a particularly high degree of flexibility in generating and capturing different pressure distributions in the medium or emitting ultrasonic signals into the medium, so that the medium can be measured or characterized particularly well.

The ultrasonic flowmeter can be designed in particular for performing at least one of the following methods.

The object mentioned at the beginning is also achieved by a method described at the beginning for operating an ultrasonic flowmeter according to the invention in that the method comprises the following steps in a first operating state: exciting at least two transducer elements of the first ultrasonic transducer array in such a way that the transducer elements excite a first guided ultrasonic wave in the medium, which propagates in the direction of the second ultrasonic transducer array, capturing the first ultrasonic wave by at least two transducer elements of the second ultrasonic transducer array, and forwarding the measuring signals of the individual transducer elements as first measuring signals to the control and evaluation unit, determining the transit time of the first ultrasonic wave from the first measuring signals by the control and evaluation unit, and that the method comprises the following steps in a second operating state: exciting at least two transducer elements of the second ultrasonic transducer array in such a way that in the medium the transducer elements excite a second guided ultrasonic wave, which propagates in the direction of the first ultrasonic transducer array, capturing the second ultrasonic wave by at least two transducer elements of the first ultrasonic transducer array and forwarding the measuring signals of the individual transducer elements as second measuring signals to the control and evaluation unit, determining the transit time of the second ultrasonic wave from the second measuring signals by the control and evaluation unit, and determining the flow rate of the flowing medium from the difference in transit time of the first and second ultrasonic waves.

The flow velocity of the flowing medium can be determined using the difference in transit time of an ultrasonic wavefield propagating in and against the direction of flow.

The transducer elements of the first ultrasonic transducer array and the transducer elements of the second ultrasonic transducer array can be controlled in such a way that they excite a flat wavefield in the measuring tube. For this purpose, the transducer elements of the ultrasonic stimulator are preferably controlled in such a way that they excite the medium at the same time and with the same amplitude. In particular, the wavelength of the excited wave corresponds approximately to the diameter of the measuring tube. Thus, a flat wave can be excited in the measuring tube that encompasses the entire flow cross-section, so that essentially all components of the flow cross-section are taken into account when determining the velocity of the flowing medium.

The smaller the coverage of the measuring tube circumference by the transducer elements, the more energy goes into unwanted wave modes. In this respect, the greatest possible coverage of the measuring tube circumference is advantageous.

The method according to the invention has the advantage that by arranging the transducer elements along the inner or outer measuring tube circumference, an ultrasonic wavefield is excited in the measuring tube in such a way that the ultrasonic wavefield essentially completely fills the measuring tube cross-section and thus essentially completely captures the flow profile. Since all velocity components of the flow profile are taken into account, the flow velocity of the flowing medium can be determined particularly accurately using the method according to the invention.

Particularly preferably, the transit times of different frequency components of an ultrasonic wave resulting from dispersion can be corrected before determining the transit time difference.

A method for dispersion correction is described for example in the paper “Measurement of Pipe and Fluid Properties With a Matrix Array-Based Ultrasonic Clamp-On Flow Meter” from Jack Massaad, Paul L. M. J. van Neer, Douwe M. van Willingen, Nicolaas de Jong, Michiel A. P. Pertijs und Martin D. Verweij, IEEE Transactions on ultrasonics, ferroelectrics, and frequency control, vol. 69, No. 1, January 2022, which is incorporated herein by reference.

For example, the phase difference which is due to different transit times is corrected in the frequency domain and the resulting dispersion-free signal is transformed back into the time domain for further evaluation, in particular to determine the transit time of the ultrasonic wave.

Alternatively or additionally, the transducer elements of the ultrasonic transducer array functioning as an ultrasonic stimulator can be controlled in such a way that an expected transit time difference between different frequency components due to dispersion is at least reduced. For example, the bandwidth of the pulsed signal introduced into the medium can be reduced. In addition, the frequency components that have a longer propagation time can be emitted with a time offset that compensates for the dispersion effect.

Furthermore, the transducer elements of the ultrasonic stimulator can be controlled in such a way that irregularities of the measuring tube or the arrangement of the transducer elements are compensated. If, for example, the thickness of the measuring tube is reduced locally, a transducer element arranged at this point can emit a signal with a lower amplitude and/or with a slight time offset.

According to a further preferred design, the first ultrasonic transducer array can be operated autonomously in at least one further operating state, so that at least one property of the medium and/or the measuring tube can be determined in the area of the first measuring tube circumference using the first ultrasonic transducer array and/or the second ultrasonic transducer array is operated autonomously in at least one further operating state, so that at least one property of the medium and/or the measuring tube can be determined in the area of the second measuring tube circumference using the second ultrasonic transducer array.

For example, in the at least one further operating state, at least one transducer element of the first ultrasonic transducer array functions at least temporarily as an ultrasonic stimulator and at least one transducer element of the first ultrasonic transducer array functions at least temporarily as an ultrasonic receiver, so that at least one property of the medium and/or the measuring tube in the region of the first measuring tube circumference can be determined using the first ultrasonic transducer array and/or in the at least one further operating state, at least one transducer element of the second ultrasonic transducer array functions at least temporarily as an ultrasonic stimulator and at least one transducer element of the second ultrasonic transducer array functions at least temporarily as an ultrasonic receiver, so that at least one property of the medium and/or of the measuring tube in the region of the second measuring tube circumference can be determined using the second ultrasonic transducer array.

The transducer element of the first ultrasonic transducer array, which functions at least temporarily as an ultrasonic stimulator, can also function temporarily as an ultrasonic receiver in the further operating state. Alternatively, one transducer element can function as an ultrasonic stimulator and another transducer element can function as an ultrasonic receiver.

The same applies to the second ultrasonic transducer array.

According to a particularly preferred design, in the at least one further operating state, at least one transducer element of the first ultrasonic transducer array emits an ultrasonic signal perpendicular to the measuring tube wall into the medium and then receives the signal reflected at the opposite inner measuring tube wall. The control and evaluation unit determines the density of the medium, taking into account the transmitted signal with the amplitude A₀ and the reflected signal with the amplitude Aₘ. In detail, the reflection coefficient R is first determined according to:

$$R = - \frac{{A}_{m}}{{A}_{0} k}$$

Here, k is a calibration factor. The calibration factor takes into account, in particular, the diffraction and attenuation of the signal by the measuring tube wall and/or by any acoustic coupling layer present, in the case where the transducer elements are arranged on the outside of the measuring tube. The calibration factor can be determined as part of a calibration measurement of a medium with a known density.

The acoustic impedance Zₘ of the medium is determined from the reflection coefficient R according to the following relationship:

$${Z}_{m} = {Z}_{Messrohrwand} \frac{1 + R}{1 - R}$$

Z_{Messrohrwand} corresponds to the acoustic impedance of the measuring tube. This is assumed to be known. If the speed of sound of the medium cₘ is not known, this is also measured, for example as described below, for example by a transit time measurement.

The density ρₘ of the medium can then be determined according to the relationship:

$${ρ}_{m} = \frac{{Z}_{m}}{{c}_{m}}$$

The density can also be determined using another transducer element or several other transducer elements so that several values for the density are available. In addition, the measurement can also be carried out with the other ultrasonic transducer array.

According to an example, in the at least one further operating state, at least one transducer element of the first ultrasonic transducer array emits an ultrasonic signal perpendicular to the measuring tube wall through the measuring tube wall into the medium and then receives a signal reflected at the opposite inner measuring tube wall and a signal that penetrates the opposite measuring tube wall and is reflected at the transition of the measuring tube wall into the outer space. Taking into account the transit time of the reflected signals, the control and evaluation unit determines the thickness of the measuring tube wall. Alternatively or additionally, the thickness of the measuring tube wall can be determined using the reflected signal, which is due to the reflection of the ultrasonic signal at the transition between the first inner measuring tube wall, into which the ultrasonic signal is emitted, and the interior of the measuring tube.

The thickness of the measuring tube wall can also be determined using other transducer elements. If the thickness of the measuring tube wall in a cross-sectional area of the measuring tube is determined at various points, the roundness of the measuring tube can be determined from this. According to a particularly preferred design of the method, the determination of the thickness of the measuring tube wall and/or the roundness of the measuring tube is carried out, at least once, before the velocity of the flowing medium is determined. Based on the measured values for the thickness of the measuring tube wall and/or the roundness of the measuring tube, the transducer elements can be individually controlled during the determination of the flow velocity in such a way that fluctuations in the thickness of the measuring tube and/or the roundness of the measuring tube are compensated for.

According to an example, in the at least one further operating state, at least one transducer element of the first ultrasonic transducer array transmits an ultrasonic signal perpendicular to the measuring tube wall through the measuring tube wall into the medium and the opposite transducer element receives the ultrasonic signal transmitted through the medium. The control and evaluation unit determines the speed of sound of the medium, taking into account the transitions between the measuring tube wall and the medium and any acoustic coupling layers present.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an example of an ultrasonic flowmeter,

FIG. 2 shows an example of an ultrasonic flowmeter in cross-section,

FIG. 3 shows an example of an ultrasonic flowmeter in cross-section,

FIG. 4 shows an example of an ultrasonic flowmeter,

FIG. 5 shows an example of an ultrasonic flowmeter

FIG. 6 shows an example of an ultrasonic flowmeter

FIG. 7 shows an example of an ultrasonic flowmeter

FIG. 8 shows an example of the method for operating an ultrasonic flowmeter,

FIG. 9 shows an example of the method for operating an ultrasonic flowmeter, and

FIG. 10 shows an example of the method for operating an ultrasonic flowmeter.

### DETAILED DESCRIPTION

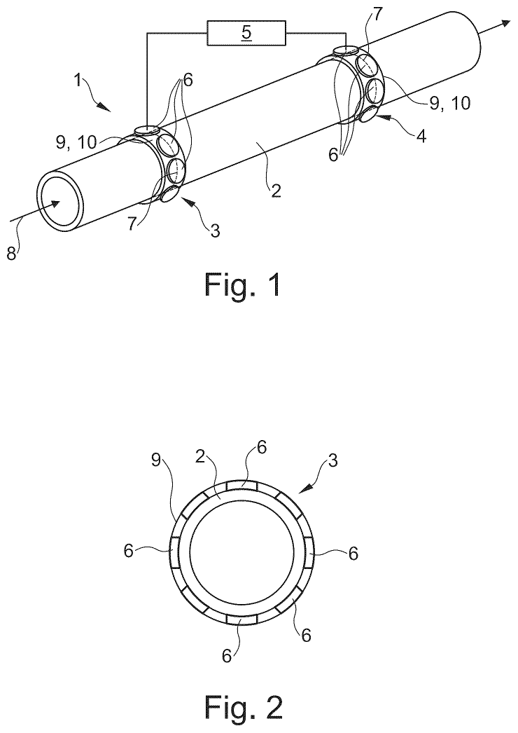

FIG. 1 shows an example of an ultrasonic flowmeter 1. The ultrasonic flowmeter 1 comprises a measuring tube 2, a first ultrasonic transducer array 3, a second ultrasonic transducer array 4 and a control and evaluation unit 5. During operation, a medium, for example a fluid or a gas, flows through the measuring tube 2. For this, the measuring tube 2 is connected to other pipes of a system in the assembled state. In addition, the measuring tube 2 shown can also already be part of the system.

The first ultrasonic transducer array 3 and the second ultrasonic transducer array 4 are arranged at a distance from each other on the measuring tube 2 as seen in the direction of flow 8.

The control and evaluation unit 5 is connected to both the first ultrasonic transducer array 3 and the second ultrasonic transducer array 4.

The ultrasonic transducer arrays 3, 4 are designed such that, in a first operating state, the first ultrasonic transducer array 3 is designed at least as an ultrasonic stimulator for exciting a guided ultrasonic wave, which is propagated through the medium during operation, and that the second ultrasonic transducer array 4 is designed at least as an ultrasonic receiver for receiving this ultrasonic wave in the first operating state.

For emitting an ultrasonic wave, the first ultrasonic transducer array has a plurality of, in particular separately controllable, transducer elements 6, wherein the plurality of, in particular separately controllable, transducer elements 6 is arranged on a first measuring tube circumference 7.

The second ultrasonic transducer array 4 also has a plurality of, in particular separately controllable, transducer elements 6 for receiving the ultrasonic wave, wherein the plurality of, in particular separately controllable, transducer elements 6 is arranged on a second measuring tube circumference 7.

In both cases, the transducer elements 6 are small in comparison to the measuring tube circumference 7.

In detail, in the example shown, the first ultrasonic transducer array 3 has eight transducer elements 6, which are arranged equidistantly around the circumference 7 of the measuring tube 2. Two transducer elements 6 are arranged diametrically opposite each other. The transducer elements 6 can be controlled, in particular separately, by the control and evaluation unit 5. For this purpose, the transducer elements 6 are arranged on a flexible band 9, wherein the flexible band 9 is placed around the measuring tube 2. In the example shown, the flexible band 9 is designed as a flexible printed circuit board 10.

The flexible printed circuit boards 10 are connected to the control and evaluation unit 5.

By controlling the individual transducer elements 6 separately, different combinations of transducer elements 6 can now be controlled in order to excite an ultrasonic wavefield in the measuring tube 2. For example, the diagonally opposite transducer elements 6 can be excited together. In addition, at least two transducer elements 6 can also be controlled with a different phase and/or amplitude in such a way that minor irregularities, such as fluctuations in the measuring tube wall thickness and/or the roundness of the measuring tube and/or the distances between the transducer elements 6, are compensated for.

In addition, wave modes can also be selectively captured at the ultrasonic receiver array arranged downstream in that only some receiver transducer elements 6 can forward the captured pressure fluctuation to the control and evaluation unit or that only some of the signals from the receiver transducer elements 6 are forwarded to the control and evaluation unit.

For example, the transducer elements 6 of the first ultrasonic transducer array 3 can be controlled in such a way that a flat wave is excited in the medium, which essentially completely covers the flow cross-section of the medium. This has the advantage that all velocity components of the flow profile are taken into account when determining the velocity of the flowing medium according to the known transit time method. For this purpose, the transducer elements 6 are controlled in such a way that all transducer elements 6 introduce a signal of the same phase and amplitude into the medium. Any irregularities that may be present can be corrected by controlling individual transducer elements 6 with a slight phase shift or slightly different amplitude.

For flow measurement, the ultrasonic transducer arrays 3, 4 are designed such that, in a second operating state, the second ultrasonic transducer array 4 is designed at least as an ultrasonic stimulator for the excitation of a guided ultrasonic wave, which propagates through the medium during operation, and that the first ultrasonic transducer array 3 is designed in the second operating state at least as an ultrasonic receiver for receiving this ultrasonic wave.

FIG. 2 shows an example of an ultrasonic flowmeter 1 in cross-section. In detail, the illustration shows the cross-section in the area of the first ultrasonic transducer array 3. The individual transducer elements 6 are arranged on the measuring tube 2. In addition, the transducer elements 6 are arranged on a flexible band 9, which is placed around the measuring tube 2. In contrast to the example shown in FIG. 1, the flexible band 9 is arranged on the side of the transducer elements 6 facing away from the measuring tube 2.

The first ultrasonic transducer array 3 shown has eight transducer elements 6, wherein two transducer elements 6 are diametrically opposite each other. If all eight transducer elements 6 are activated in the same way during operation, a flat wave that essentially covers the entire cross-section of the flowing medium can be excited in the measuring tube 2. If the flow velocity of the flowing medium is determined based on the transit time of this ultrasonic wave, all velocity components of the flow profile can be taken into account in an advantageous manner.

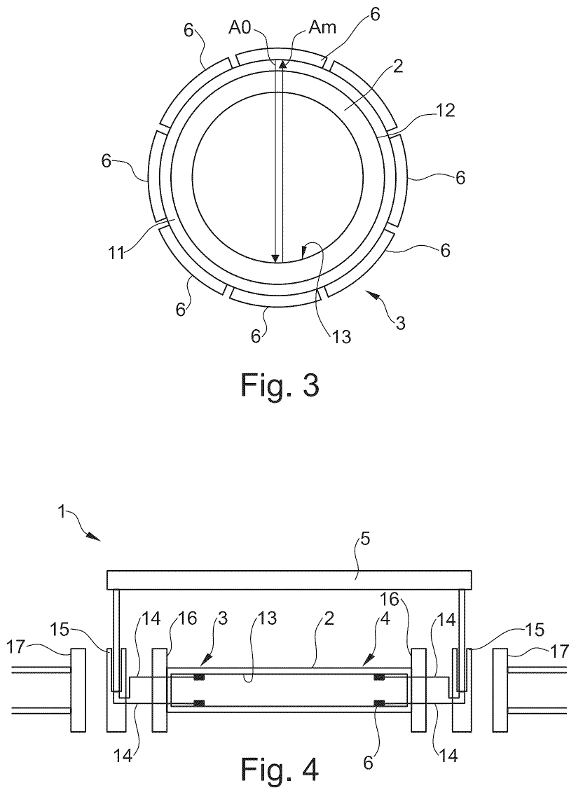

FIG. 3 shows an example of a first ultrasonic transducer array 3 arranged on a measuring tube 2 in cross-section. An acoustic coupling layer 11 is arranged between the transducer elements 6 and the outer measuring tube wall 12, which improves the sound transmission into the inside of the measuring tube.

An operating state is shown in which the ultrasonic transducer array 3 is operated in such a way that a transducer element 6 emits an ultrasonic signal with an amplitude A₀ vertically into the measuring tube 2 and receives the signal reflected at the opposite inner measuring tube wall 13, which has an amplitude Aₘ. In the operating state shown, the ultrasonic transducer array 3 is therefore not used to determine the velocity of a flowing medium, but to determine a parameter of the medium, in particular the density of the medium.

FIG. 4 shows a further example of an ultrasonic flowmeter 1 in longitudinal section with a measuring tube 2, a first ultrasonic transducer array 3 and a second ultrasonic transducer array 4, wherein the first ultrasonic transducer array 3 and the second ultrasonic transducer array 4 are arranged on the inner measuring tube wall 13.

Cables 14 are provided for contacting the transducer elements 6, which are led into the outer space of the measuring tube 2 via connecting element 15.

The measuring tube 2 has flanges 16 at the ends, which are connected to pipe flanges 17 arranged on these pipes for connection to pipes of an existing pipe system. A connecting element 15 is arranged between each flange 16 and a pipe flange 17. In the example shown, the connecting element 15 has channels via which the cables 14 are guided into the exterior space of the measuring tube 2. In the exterior space of the measuring tube 2, the cables 14 are connected to the control and evaluation unit 5. For illustration purposes, the flanges 16, the pipe flanges 17 and the connecting elements 15 are arranged at a distance from each other.

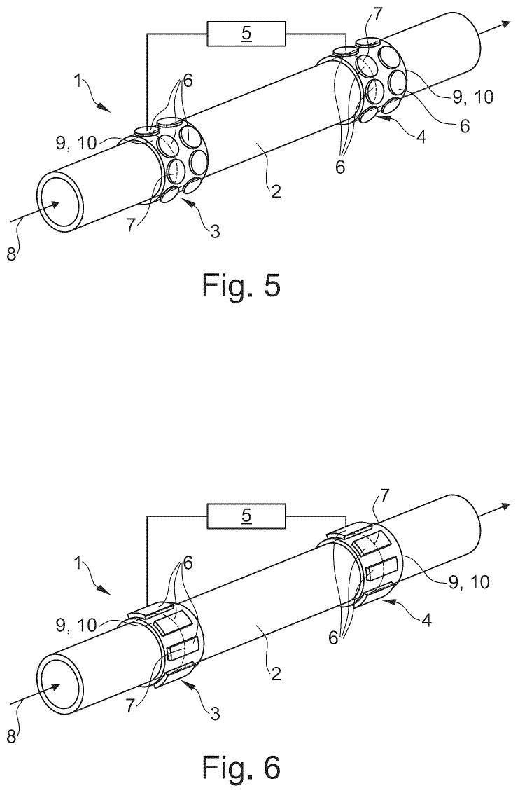

FIG. 5 shows another example of an ultrasonic flowmeter 1. In the example shown, the transducer elements 6 of the first ultrasonic transducer array 3 and the transducer elements 6 of the second ultrasonic transducer array 4 are arranged in two rows on the band 9. As a result, the transducer elements 6 of both the first ultrasonic transducer array 3 and the transducer elements 6 of the second ultrasonic transducer array 4 are arranged in two rows on the measuring tube 2. During operation, this arrangement can be used to amplify the desired wave mode, which is excited by the transducer elements 6 of the first row in the medium, by selectively controlling the transducer elements of the second row in the flow direction. For this purpose, the transducer elements 6 are controlled with a slight time delay by the control and evaluation unit during operation.

FIG. 6 shows a further example of an ultrasonic flowmeter 1. In the example shown, the transducer elements 6 are not disc-shaped but are designed in the shape of a cuboid with a rectangular base. In addition, the transducer elements 6 are arranged on the measuring tube 2 in such a way that the long side of the rectangles is oriented in the flow direction of the medium. This design has the advantage that there is a particularly large contact surface between the transducer elements 6 and the measuring tube 2, so that a lot of energy can be introduced into the medium during operation.

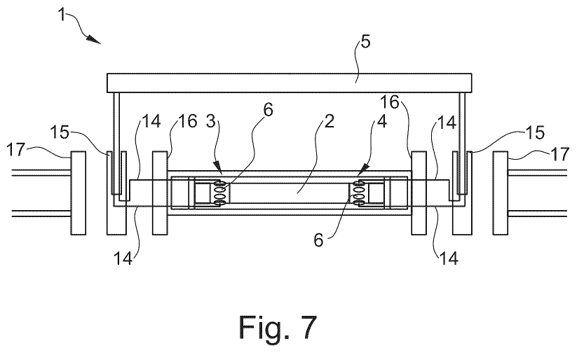

FIG. 7 shows schematically an example of an ultrasonic flowmeter 1. In the example shown, the measuring tube 2 is designed as a measuring tube insert, wherein the measuring tube insert is inserted into a tube of an existing pipe system. A first ultrasonic transducer array 3 and a second ultrasonic transducer array 4 are arranged on the outer circumference of the measuring tube 2. Both ultrasonic transducer arrays 3 and 4 have transducer elements 6, which are arranged around the measuring tube 2 by means of a flexible circuit board. The transducer element 6 is contacted via cables 14, which are routed into the outer chamber via a flange connection 16, 17 and a connecting element 15, which can be arranged between the flanges, and which cables are connected to the control and evaluation unit 5 in the outer chamber. Alternatively, the ultrasonic transducer arrays 3 and 4 can also be arranged on the inner measuring tube wall in the case of a measuring tube designed as a measuring tube insert.

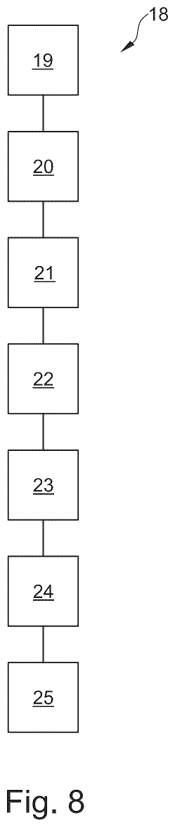

FIG. 8 shows an example of the method 18 for operating an ultrasonic flowmeter, wherein the ultrasonic flowmeter is designed as shown in FIG. 1. The ultrasonic flowmeter is integrated into an existing pipe system. In addition, a medium flows through the measuring tube.

The ultrasonic transducer arrays 3, 4 are designed and controlled in such a way that in a first operating state the first ultrasonic array 3 functions as an ultrasonic stimulator and the second ultrasonic array 4 functions as an ultrasonic receiver and that in a second operating state the first ultrasonic array 3 functions as an ultrasonic receiver and the second ultrasonic array 4 functions as an ultrasonic stimulator.

In a first operational state, the method 18 comprises the following steps:
exciting 19 at least two transducer elements 6 of the first ultrasonic array 3 in such a way that the transducer elements 6 excite a first guided ultrasonic wave in the medium, which propagates in the direction of the second ultrasonic transducer array 4,
capturing 20 the first ultrasonic wave by at least two transducer elements 6 of the second ultrasonic transducer array 4, and forwarding the measured signals of the individual transducer elements 6 as first measuring signal to the control and evaluation unit 5,
determining 21 the transit time of the first ultrasonic wave from the first measuring signals by the control and evaluation unit 5.

In the second operating state, the method 18 comprises the following steps:
exciting 22 at least two transducer elements 6 of the second ultrasonic transducer array 4 in such a way that the transducer elements 6 excite a second guided ultrasonic wave in the medium, which propagates in the direction of the first ultrasonic transducer array 3,
capturing 23 the second ultrasonic wave by at least two transducer elements 6 of the first ultrasonic transducer array 3, and forwarding the measuring signals of the individual transducer elements as second measuring signal to the control and evaluation unit 5,
determining 24 the transit time of the second ultrasonic wave from the second measuring signals by the control and evaluation unit 5, and
determining 25 the flow rate of the flowing medium from the difference in transit time of the first and second ultrasonic waves.

The method according to the invention has the advantage that, in particular in the case in which a flat ultrasonic wavefield is excited, the velocity of the flowing medium can be determined with a reciprocating transit time measurement, wherein all velocity components of the flow profile can be taken into account. Methods known from the prior art use a plurality of ultrasonic transducers matched in pairs to measure different areas of the flow profile of a flowing medium, wherein each pair of ultrasonic transducers measures an area of the flow profile.

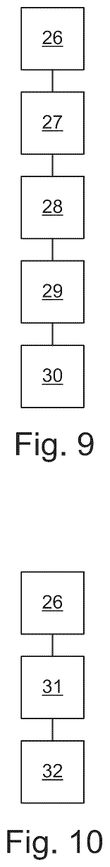

FIG. 9 shows an example of the method for operating an ultrasonic flowmeter, wherein the ultrasonic flowmeter is designed as shown in FIG. 1. The example shown shows a further operating state of the ultrasonic flowmeter in which the density of the medium is determined.

The method comprises the following steps:

In a first step 26, at least one transducer element 6 of the first ultrasonic transducer array 3 emits an ultrasonic signal with an amplitude A₀ perpendicular to the measuring tube wall into the medium. In a subsequent step 27, the transducer element 6 receives the signal reflected at the opposite inner measuring tube wall, which has an amplitude Aₘ. From the emitted amplitude A₀ and the received amplitude Aₘ and a calibration factor k, the control and evaluation unit 5 determines the reflection coefficient R in the next step 28. The acoustic impedance of the medium Zₘ is determined 29 from the reflection coefficient R, taking into account the known acoustic impedance of the measuring tube wall Z_{Messrohrwand}.

In turn, the density ρm of the medium can be determined 30 from the acoustic impedance Zₘ of the medium using the speed of sound cₘ of the medium.

In the same way, the density of the medium can be determined with the second ultrasonic transducer array 4, whereby the density of the medium determined in the area of the first measuring tube circumference can be checked.

FIG. 10 shows an example of the method for operating an ultrasonic flowmeter 1 designed as shown in FIG. 1. The method shown in FIG. 10 also relates to a further operating state of the flowmeter, in which an ultrasonic transducer array is used to determine a parameter of the measuring arrangement, in detail the thickness of the measuring tube wall.

For this purpose, at least one transducer element of the first ultrasonic transducer array transmits an ultrasonic signal perpendicular to the measuring tube wall through the measuring tube wall into the medium.

In the subsequent step 31, the transducer element receives the signal reflected at the opposite inner measuring tube wall as well as a signal that penetrates the opposite measuring tube wall and is reflected at the transition of the measuring tube wall into the exterior space, and forwards these signals to the control and evaluation unit. Alternatively or additionally, the signal reflected on the first inner measuring tube wall, i.e. the measuring tube wall into which the signal is emitted, can also be recorded and evaluated as follows.

In a next step 32, the control and evaluation unit 5 determines the thickness of the measuring tube wall in the area of the first measuring tube circumference, taking into account the transit time of the reflected signals.

Particularly preferably, the thickness of the measuring tube wall can be determined locally in the area of the first measuring tube circumference using various diametrically opposed transducer elements.

The results of the measurement of the measuring tube thickness at different points can be used to individually control the transducer elements for determining the velocity of the flowing medium in such a way that fluctuations in the measuring tube thickness are compensated for.

The thickness of the measuring tube wall can also be determined in the same way as described above using the second ultrasonic transducer array, preferably using different diametrically opposed transducer pairs. The measured thickness of the measuring tube wall can also be taken into account when evaluating the signals captured by the transducer elements. In detail, fluctuations in the measuring tube thickness can be corrected during the evaluation.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An ultrasonic flowmeter, comprising:
a measuring tube;
a first ultrasonic transducer array;
a second ultrasonic transducer array; and
a control and evaluation unit,
wherein a medium flows through the measuring tube during operation,
wherein the first ultrasonic transducer array and the second ultrasonic transducer array are arranged on the measuring tube at a distance from one another as viewed in the direction of flow,
wherein the control and evaluation unit is connected to the first ultrasonic transducer array and to the second ultrasonic transducer array,
wherein, in a first operating state, the first ultrasonic transducer array is designed at least as an ultrasonic stimulator for the excitation of a guided ultrasonic wave which is propagated through the medium during operation, and the second ultrasonic transducer array is designed at least as an ultrasonic receiver for receiving the ultrasonic wave,
wherein the first ultrasonic transducer array has at least two transducer elements,
wherein the least two transducer elements is arranged on a first measuring tube circumference,
wherein the second ultrasonic transducer array has a least two transducer elements, wherein the least two transducer elements is arranged on a second measuring tube circumference, and
wherein the transducer elements are small in comparison with the measuring tube circumference.

2. The ultrasonic flowmeter according to claim 1, wherein the transducer elements of the first ultrasonic transducer array and the transducer elements of the second ultrasonic transducer array are arranged on the outer measuring tube circumference or that the transducer elements of the first ultrasonic transducer array and the transducer elements of the second ultrasonic transducer array are arranged on the inner measuring tube circumference.

3. The ultrasonic flowmeter according to claim 1, wherein the measuring tube is part of an existing pipe system or the measuring tube is connectable to the pipes of a pipe system, for example via a flange connection, or the measuring tube is a measuring tube insert that is adapted to be inserted into a pipe of an existing system.

4. The ultrasonic flowmeter according to claim 1, wherein the transducer elements of the first ultrasonic transducer array are arranged, or substantially equidistant from one another, on a flexible band which is laid around the measuring tube and/or wherein the transducer elements of the second ultrasonic transducer array are arranged, or substantially equidistant from one another, on a flexible band which is laid around the measuring tube.

5. The ultrasonic flowmeter according to claim 1, wherein the transducer elements of the first ultrasonic transducer array are arranged substantially equidistantly along the complete first circumference of the measuring tube and/or wherein the transducer elements of the second ultrasonic transducer array are arranged substantially equidistantly along the complete second measuring tube circumference.

6. The ultrasonic flowmeter according to claim 1, wherein the transducer elements of the first ultrasonic transducer array are arranged on a flexible printed circuit board which is placed around the measuring tube and/or wherein the transducer elements of the second ultrasonic transducer array are arranged on a flexible printed circuit board which is placed around the measuring tube.

7. The ultrasonic flowmeter according to claim 1, wherein the first ultrasonic transducer array comprises at least four transducer elements and/or wherein the second ultrasonic transducer array comprises at least four transducer elements.

8. The ultrasonic flowmeter according to claim 1, wherein, in a second operating state, the first ultrasonic transducer array is also designed as an ultrasonic receiver for receiving an ultrasonic wave, and wherein, in a second operating state, the second ultrasonic transducer array is also designed as an ultrasonic stimulator for the excitation of a guided ultrasonic wave which is propagated through the medium during operation.

9. The ultrasonic flowmeter according to claim 1, wherein the first ultrasonic transducer array is designed such that in a third operating state at least one transducer element is designed as an ultrasonic stimulator and at least one transducer element is designed as an ultrasonic receiver and/or that the second ultrasonic transducer array is designed in such a way that in a third operating state at least one transducer element is designed as an ultrasonic stimulator and at least one transducer element is designed as an ultrasonic receiver.

10. A method to operate the ultrasonic flowmeter according to claim 1, wherein a medium flows through the measuring tube, and wherein, in a first operating state, the first ultrasonic transducer array functions as an ultrasonic stimulator and the second ultrasonic transducer array functions as an ultrasonic receiver and wherein, in a second operating state, the first ultrasonic transducer array functions as an ultrasonic receiver and the second ultrasonic transducer array functions as an ultrasonic stimulator, the method comprising in the first operating state:
exciting at least two transducer elements of the first ultrasonic transducer array such that the transducer elements excite a first guided ultrasonic wave in the medium, which propagates in the direction of the second ultrasonic transducer array,
capturing the first ultrasonic wave by at least two transducer elements of the second ultrasonic transducer array, and forwarding the measuring signals of the individual transducer elements as first measuring signals to the control and evaluation unit,
determining the transit time of the first ultrasonic wave from the first measuring signals by the control and evaluation unit,
the method comprising in a second operating state:
exciting at least two transducer elements of the second ultrasonic transducer array such that the transducer elements excite a second guided ultrasonic wave in the medium, which propagates in the direction of the first ultrasonic array,
capturing the second ultrasonic wave by at least two transducer elements of the first ultrasonic transducer array, and forwarding the measuring signals of the individual transducer elements as second measuring signals to the control and evaluation unit,
determining the transit time of the second ultrasonic wave from the second measuring signals by the control and evaluation unit, and
determining the flow rate of the flowing medium from the difference in transit time of the first and second ultrasonic waves.

11. The Method according to claim 10, wherein, before determining the transit time difference, the transit times of different frequency components of an ultrasonic wave which arise due to dispersion are corrected.

12. The Method according to claim 10, wherein the transducer elements of the ultrasonic transducer array functioning as an ultrasonic stimulator are controlled in such a way that an expected difference in transit time between individual frequency components caused by dispersion is reduced.

13. The Method according to claim 10, wherein, in at least one further operating state, at least one transducer element of the first ultrasonic transducer array functions as an ultrasonic stimulator and at least one transducer element of the first ultrasonic transducer array functions as an ultrasonic receiver, so that at least one property of the medium and/or of the measuring tube in the region of the first measuring tube circumference is adapted to be determined with the first ultrasonic transducer array, and/or wherein, in at least one further operating state, at least one transducer element of the second ultrasonic transducer array functions as an ultrasonic stimulator and at least one transducer element of the second ultrasonic transducer array functions as an ultrasonic receiver, so that at least one property of the medium and/or of the measuring tube in the region of the second measuring tube circumference are adapted to be determined using the second ultrasonic transducer array.

14. The Method according to claim 13, wherein, in the at least one further operating state, the at least one transducer element of the first ultrasonic transducer array emits an ultrasonic signal perpendicular to the measuring tube wall into the medium and then receives the signal reflected at the opposite inner measuring tube wall, and wherein the control and evaluation unit determines the density of the medium, taking into account the emitted signal and the reflected signal, and/or wherein, in the at least one further operating state, the at least one transducer element of the second ultrasonic transducer array emits an ultrasonic signal perpendicular to the measuring tube wall into the medium and then receives the signal reflected at the opposite inner measuring tube wall, and wherein the control and evaluation unit determines the density of the medium, taking into account the emitted signal and the reflected signal.

15. The Method according to claim 13, wherein, in the at least one further operating state, at least one transducer element of the first ultrasonic transducer array emits an ultrasonic signal substantially perpendicular to the measuring tube wall through the measuring tube wall into the medium and then receives a signal reflected at the opposite inner measuring tube wall and a signal which penetrates into the opposite measuring tube wall and is reflected at the transition of the measuring tube wall into the outer space, and wherein the control and evaluation unit determines the thickness of the measuring tube wall in the region of the first measuring tube circumference, taking into account the transit time of the reflected signals, and/or wherein, in the at least one further operating state, at least one transducer element of the second ultrasonic transducer array emits an ultrasonic signal substantially perpendicular to the measuring tube wall through the measuring tube wall into the medium and then receives a signal reflected at the opposite inner measuring tube wall and a signal which penetrates into the opposite measuring tube wall and is reflected at the transition of the measuring tube wall into the outer space, and wherein the control and evaluation unit determines the thickness of the measuring tube wall in the region of the second measuring tube circumference taking into account the transit time of the reflected signals.

16. The Method according to claim 13, wherein, in the at least one further operating state, at least one transducer element of the first ultrasonic transducer array emits an ultrasonic signal substantially perpendicular to the measuring tube wall through the measuring tube wall into the medium and the opposite transducer element receives the ultrasonic signal transmitted through the medium, and wherein the control and evaluation unit determines the speed of sound of the medium, taking into account the transitions between the measuring tube wall and the medium and any acoustic coupling layers present, and/or wherein, in the at least one further operating state, at least one transducer element of the second ultrasonic transducer array emits an ultrasonic signal substantially perpendicular to the measuring tube wall through the measuring tube wall into the medium and the opposite transducer element receives the ultrasonic signal transmitted through the medium, and wherein the control and evaluation unit determines the speed of sound of the medium, taking into account the transitions between the measuring tube wall and the medium and any acoustic coupling layers present.
